(19) United States
(12) Patent Application Publication
(10) Pub. No.: US 2021/0053860 A1
(43) Pub. Date: Feb. 25, 2021

(54) MOLD FOR MOLDING WAFER-LEVEL LENS AND METHOD FOR MOLDING WAFER-LEVEL LENS

(71) Applicant: AAC Optics Solutions Pte. Ltd., Singapore city (SG)

(72) Inventors: Peter Krohne Nielsen, Farum (DK); Niels Christian Roemer Holme, Farum (DK); Bingke Zhu, Shenzhen (CN); Zhengmin Banjamin Pan, L.A., CA (US)

(21) Appl. No.: 16/986,309

(22) Filed: Aug. 6, 2020

(30) Foreign Application Priority Data
Aug. 20, 2019 (CN) 201910770836.2

(51) Int. Cl. C03B 23/035; G02B 3/00

(52) U.S. Cl. CPC C03B 23/0357; G02B 3/0031

(57) ABSTRACT

Provided is a mold, including: a lower mold matching and molding a convex surface, and an upper mold corresponding to the lower mold. The lower mold includes a first lens molding surface right facing the upper mold. A molding cavity is formed between the first lens molding surface and the upper mold. The first lens molding surface recesses towards a direction facing away from the upper mold to form recessed portions and grooves surrounding the recessed portions. The groove is in communication with the recessed portion. Two adjacent grooves are in communication with each other. An exhaust passage is formed in the first lens molding surface. The exhaust passage communicates with the grooves and extends to an outer edge of the lower mold. In a process of molding the lens, air in the recessed portion is discharged to an outside of the mold through the groove and the exhaust passage.

### TECHNICAL FIELD

The present disclosure relates to the field of lens manufacturing technology, and more particularly, to a mold for molding a wafer-level lens and a method for molding a wafer-level lens.

### BACKGROUND

A basic process for manufacturing a lens is usually to distribute a material such as glass or resin into a surface of a lower mold, put an upper mold portion on a lower mold portion, cause a concave surface and a convex surface to face each other to form a lens-shaped lens cavity, and then cut a lens formed within the lens cavity into individual lenses or use the lens directly.

For a lens including at least one convex surface, when designing a mold, at least one of an upper mold and a lower mold is provided with a recessed cavity, and the recessed cavity will be filled with gas. In addition, when adding a lens material, the gas will be trapped in the recessed cavity, which will cause bubbles or the like in the lens after compression.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic diagram of a lower mold for molding a wafer-level lens according to an embodiment of the present disclosure;

FIG. 2 is a cross-sectional diagram taken along line A-A of FIG. 1;

FIG. 3 is a cross-sectional diagram taken along line B-B of FIG. 1;

FIG. 4 is an enlarged partial diagram of Portion a in FIG. 3; and

FIG. 5 is a cross-sectional diagram of a mold for molding a wafer-level lens according to an embodiment of the present disclosure.

### REFERENCE NUMERAL

1—lower mold;
   11—first lens molding surface;
      111—recessed portion;
      112—groove;
      113—connecting portion;
         113a—bottom surface;
   12—exhaust passage;
2—lens;
3—upper mold.

### DESCRIPTION OF EMBODIMENTS

The present disclosure will be further illustrated with reference to the accompanying drawings and the embodiments.

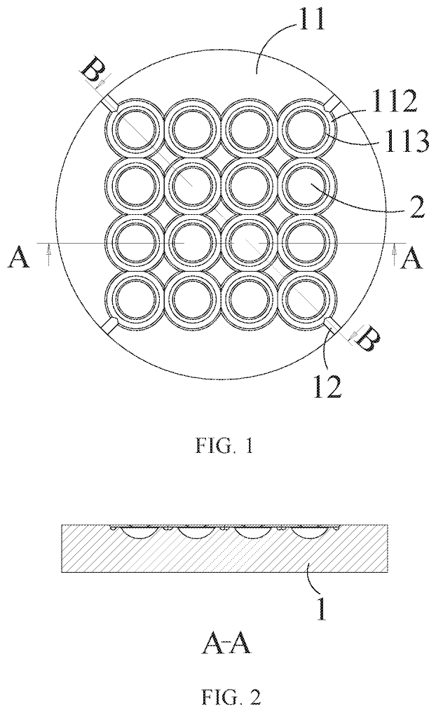

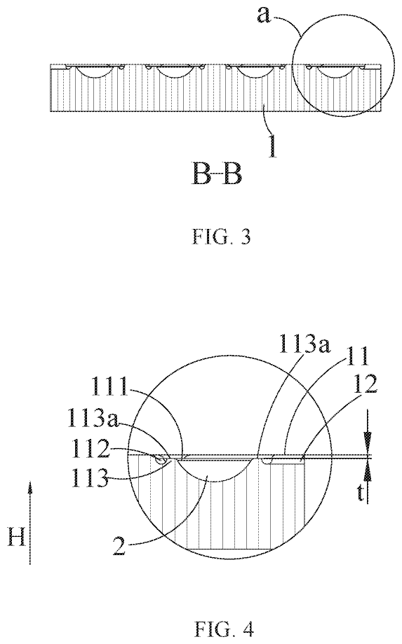

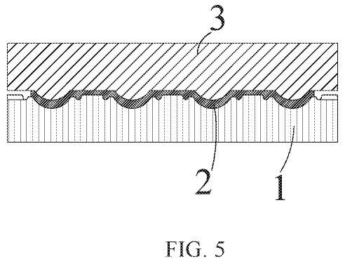

As shown in FIG. 1, FIG. 2, FIG. 3, FIG. 4 and FIG. 5, an embodiment of the present disclosure provides a mold for molding a wafer-level lens. The lens has a convex surface on at least one side. The mold includes a lower mold 1 correspondingly matching and molding the convex surface, and an upper mold 3 corresponding to the lower mold 1. The lower mold 1 includes a first lens molding surface 11 right facing the upper mold 3, and a molding cavity is formed between the first lens molding surface and the upper mold 3. The molding cavity is typically a vacuum cavity. The first lens molding surface 11 recesses towards a direction facing away from the upper mold 3 to form a plurality of recessed portions 111 and a plurality of grooves 112 surrounding the recessed portions 111. The groove 112 is in communication with the recessed portion 111, and two adjacent grooves 112 are in communication with each other. An exhaust passage 12 is formed in the first lens molding surface 11, and the exhaust passage 12 communicates with the groove 112 and extends to an outer edge of the lower mold 1.

In a process of molding the lens, air in the recessed portion 111 is discharged to an outside of the mold through the groove 112 and the exhaust passage 12 sequentially, thereby reducing a possibility of occurrence of bubbles in the lens 2.

By providing the groove 112 on an outer circumference of the recessed portion 111, a volume of a cavity of the mold can be appropriately compensated, such that the volume of the cavity in the lower mold 1 is close to a volume of a protrusion on the upper mold 3, thereby reducing a volume difference between the upper mold 3 and the lower mold 1 and thus preventing a large amount of material from flowing to a center of the recessed portion 111. Namely, a radial material flow can be reduced to make a radial flow be close to zero, so as to reduce technical problems that might affect the quality of the lens 2, such as bubbles, cracking, lack of filler in the lens 2 and the like.

In addition, due to the reduction of the radial material flow, it is also possible to decrease a probability of technical problems such as occurrence of changes in a thickness on a wafer in the lens 2, astigmatism and shape errors on the lens 2, occurrence of streamlines on the lens 2, lack of filler in the chamber and the like, and wear of the surface and the layer of the lens 2 can also be reduced.

In a specific embodiment, the exhaust passage 12 is formed by recessing from the first lens molding surface 11. Air in the recessed portion 111 is sequentially discharged to an outside of the mold through the groove 112 and the exhaust passage 12, so as to reduce the possibility of occurrence of bubbles in the lens 2. Moreover, since the exhaust passage 12 is formed by recessing from the first lens molding surface 11, it is easy to process.

In a specific embodiment, connecting portions 113 are formed in the first lens molding surface 11 and are spaced apart from each other. The connecting portion is provided between one groove 112 and one recessed portion 111 adjacent to the groove 112. The groove 112 communicates with the recessed portion 111 via the connecting portion 113. The air in the recessed portion 111 is sequentially discharged to the outside of the mold through the groove 112 and the exhaust passage 12.

The connecting portion 113 is a surface formed by recessing from the first lens molding surface 11 towards a direction facing away from the upper mold 3, so that it is easy to process.

As shown in FIG. 4, a recessing depth t of the connecting portion 113 satisfies: 10 μm<t<30 μm.

For gas discharging, the recessing depth of the connecting portion 113 needs to be large enough for gas to escape through the exhaust passage 12. If the recessing depth of the connecting portion 113 is too small, it will take a long time for the gas to escape, which results in a too long molding cycle.

Specifically, the gas discharging time is 1 minute. The recessing depth of the suitable connecting portion 113 can be estimated by using the Poiseuilles law and the ideal gas equation. Generally, the recessing depth of the connecting portion 113 is 20 μm. If a faster discharging is desired, the groove 112 having a larger cross section and the connecting portion 113 having a larger recessing depth can be designed.

The connecting portion 113 includes a bottom surface 113a. Along a height direction H, the bottom surface 113a is lower than a height of the first lens molding surface 11. The exhaust passage 12 is disposed at the lower mold 1, and the exhaust passage 12 communicates with the groove 112. The gas in the recessed portion 111 can be discharged to the outside of the mold through the groove 112 and through the exhaust passage 12, thereby reducing the possibility of occurrence of bubbles in the lens 2.

In a specific embodiment, a height difference between the bottom surface 113a and the first lens molding surface 11 is 20 microns. The gas in the recessed portion 111 can be discharged, through the groove 112 and through the exhaust passage 12, to the outside of the mold for molding the wafer-level lens, thereby reducing the possibility of occurrence of bubbles in the lens 2.

In a specific embodiment, two adjacent grooves 112 communicate with each other. The gas in the recessed portion 111 can be discharged to the outside of the mold along the groove 112 and through the exhaust passage 12, thereby reducing the possibility of occurrence of bubbles in the lens 2.

In a specific embodiment, the groove 112 has a continuous ring shape to prevent a large amount of material from flowing to a center of the first groove 112. Namely, a radial material flow can be reduced to make a radial flow be close to zero, so as to reduce technical problems that might affect the quality of the lens 2, such as bubbles, cracking, lack of filler in the lens 2 and the like.

In a specific embodiment, an inner surface of the groove 112 is a smooth curved surface, making it possible to decrease a probability of occurrence of changes in a thickness on a wafer in the lens 2, astigmatism and shape errors on the lens 2, and occurrence of streamlines on the lens 2.

As shown in FIGS. 2 and 3, the groove 112 has an arc shape in cross section, making it possible to decrease a probability of occurrence of changes in a thickness on a wafer in the lens 2, astigmatism and shape errors on the lens 2, and occurrence of streamlines on the lens 2.

In a specific embodiment, the inner surface of the recessed portion 111 is a spherical surface, so that it is easy to process and the processing efficiency of the lens 2 is improved.

As shown in FIG. 1, a plurality of recessed portions 111 is arranged in a matrix, and a plurality of lenses 2 can be manufactured at the same time. The plurality of lenses 2 will be obtained by cutting after the completion of manufacturing. The arrangement of the cavities may be in a square pattern or a polygonal close-packed pattern.

In a specific embodiment, there are a plurality of exhaust passages 12 symmetrically disposed with respect to a center line of the mold, so that the gas in the recessed portion 111 can be quickly discharged, and can be discharged to the outside of the mold through the exhaust passage 12, thereby reducing the possibility of occurrence of bubbles in the lens 2.

The mold of the present embodiment of the present disclosure is merely an example, and the mold can be any mold capable of manufacturing a lens 2 having any combination including a concave optical surface or a convex optical surface.

The embodiment of the present disclosure further provides a method for molding a wafer-level lens, including:

providing a glass substrate;

causing the glass substrate to be carried on the first lens molding surface of the lower mold as described in any one of the technical aspects above;

aligning the upper mold 3 with the lower mold to form a molding cavity, and fixing the glass substrate in the molding cavity;

heating the glass substrate;

pressurizing the glass substrate to mold the glass substrate and discharging gas generated in the recessed portion through the groove and the exhaust passage to an outside of the mold; and demolding.

In a process of molding the lens, air in the recessed portion 111 is discharged to the outside of the mold through the groove 112 and the exhaust passage 12 sequentially, thereby reducing the possibility of occurrence of bubbles in the lens 2.

By providing the groove 112 on an outer circumference of the recessed portion 111, a volume of a cavity of the mold can be appropriately compensated, such that the volume of the cavity in the lower mold 1 is close to a volume of a protrusion on the upper mold 3, thereby reducing a volume difference between the upper mold 3 and the lower mold 1 and thus preventing a large amount of material from flowing to a center of the recessed portion 111. Namely, a radial material flow can be reduced to make a radial flow be close to zero, so as to reduce technical problems that might affect the quality of the lens 2, such as bubbles, cracking, lack of filler in the lens 2 and the like.

In addition, due to the reduction of the radial material flow, it is also possible to decrease a probability of technical problems such as occurrence of changes in a thickness on a wafer in the lens 2, astigmatism and shape errors on the lens 2, occurrence of streamlines on the lens 2, lack of filler in the chamber and the like, and wear of the surface and the layer of the lens 2 can also be reduced.

What has been described above is only an embodiment of the present disclosure, and it should be noted herein that one ordinary person skilled in the art can make improvements without departing from the inventive concept of the present disclosure, but these are all within the scope of the present disclosure.

What is claimed is:

1. A mold for molding a wafer-level lens, the lens having a convex surface on at least one side, wherein the mold comprises:
a lower mold correspondingly matching and molding the convex surface; and
an upper mold corresponding to the lower mold,
wherein the lower mold comprises a first lens molding surface right facing the upper mold, and a molding cavity is formed between the first lens molding surface and the upper mold;
the first lens molding surface recesses towards a direction facing away from the upper mold to form a plurality of recessed portions and a plurality of grooves surrounding the plurality of recessed portions, each of the plurality of grooves is in communication with a corresponding one of the plurality of recessed portions, and two adjacent grooves of the plurality of grooves are in communication with each other;
an exhaust passage is formed in the first lens molding surface, and the exhaust passage communicates with the plurality of grooves and extends to an outer edge of the lower mold; and
in a process of molding the lens, air in each of the plurality of recessed portions is discharged to an outside of the mold through a corresponding one of the plurality of grooves and the exhaust passage sequentially.

2. The mold for molding a wafer-level lens as described in claim 1, wherein the exhaust passage is formed by recessing from the first lens molding surface.

3. The mold for molding a wafer-level lens as described in claim 1, wherein a plurality of connecting portions is formed in the first lens molding surface and is spaced apart from each other, each of the plurality of connecting portions is provided between one groove of the plurality of grooves and one of the plurality of recessed portions adjacent to the one groove, and the one groove communicates with the recessed portion via the connecting portion.

4. The mold for molding a wafer-level lens as described in claim 3, wherein each of the plurality of connecting portions is a surface formed by recessing from the first lens molding surface towards the direction facing away from the upper mold.

5. The mold for molding a wafer-level lens as described in claim 3, wherein a recessing depth t of each the plurality of connecting portions satisfies: 10 μm<t<30 μm.

6. The mold for molding a wafer-level lens as described in claim 3, wherein each of the plurality of connecting portions has a recessing depth of 20 μm.

7. The mold for molding a wafer-level lens as described in claim 1, wherein each of the plurality of grooves is in a continuous ring shape.

8. The mold for molding a wafer-level lens as described in claim 1, wherein an inner surface of each of the plurality of grooves is a smooth curved surface.

9. The mold for molding a wafer-level lens as described in claim 1, wherein an inner surface of each of the plurality of recessed portions is a spherical surface.

10. The mold for molding a wafer-level lens as described in claim 1, wherein the plurality of recessed portions is arranged in a matrix.

11. The mold for molding a wafer-level lens as described in claim 1, wherein a plurality of exhaust passages is provided and is symmetrically disposed with respect to a center line of the mold.

12. A method for molding a wafer-level lens, comprising:
providing a glass substrate;
causing the glass substrate to be by carried on the first lens molding surface of the lower mold of as described in claim 1;
aligning the upper mold with the lower mold to form a molding cavity, and fixing the glass substrate in the molding cavity;
heating the glass substrate;
evacuating the molding cavity;
pressurizing the glass substrate to mold the glass substrate and discharging gas generated in the plurality of recessed portions through the plurality of grooves and the exhaust passage to an outside of the mold; and
demolding.
